(19) United States
(12) Patent Application Publication
(10) Pub. No.: US 2021/0342768 A1
(43) Pub. Date: Nov. 4, 2021

(54) Reserve System and Method

(71) Applicant: The Boeing Company, Chicago, IL (US)

(72) Inventors: Oleksandr Basanets, Montreal (CA); Dhruv Raj Sharma, Montreal (CA)

(73) Assignee: The Boeing Company, Chicago, IL (US)

(21) Appl. No.: 16/862,892

(22) Filed: Apr. 30, 2020

(51) Int. Cl. G06Q 10/06; G06Q 50/30; G06Q 10/04; G06N 5/04; G06F 17/18

(52) U.S. Cl. CPC G06Q 10/063116; G06Q 10/06312; G06F 17/18; G06Q 10/04; G06N 5/04; G06Q 50/30

(57) ABSTRACT

A reserve system and method for determining a quantity of forecasted reserve for a crew-grouping for a quantity of scheduled flights in a future time period is disclosed. The reserve system may comprise a controller configured to receive a crew-grouping and a quantity of scheduled flights for an aircraft in a future time period, and a historical data set associated with the crew-grouping for a previous time period. The controller is further configured to determine a quantity of forecasted reserve based on: an interquartile range of values in the historical data set for a quantity of actual used reserve of the crew-grouping per day for the aircraft; or the quantity of scheduled flights per day in the future time period and a transformed interquartile range of a plurality of data points associated with the historical data set; and to transmit the quantity of forecasted reserve to a crew rostering system.

### TECHNICAL FIELD

The present disclosure generally relates to systems and methods of scheduling reserve crew members for aircraft.

### BACKGROUND

Airline flight planning typically includes use of a crew pairing system and a crew rostering system. The crew pairing system combines aircraft flights scheduled in a future time period into flight patterns that start from and end at the same (crew) base (designated airport near where a crew member resides), such flight patterns are referred to herein as “scheduled flights”.

The crew rostering system assigns crew members to scheduled flights, ground duties or reserve duty. When a crew member is assigned to reserve duty he/she is a reserve crew (member) that is on-call to perform another crew member's assigned duties when the other crew member is unable to perform (e.g., the crew member is sick, delayed or the like). The assignment of crew members is complex as crew parameters such as a crew member's rank, base, and qualifications for working on a particular aircraft type (“technical qualifications”) may need to be considered as well as applicable legalities and other constraints.

For use in assigning crew members to scheduled flights, the scheduled flights are received by the crew rostering system from the crew pairing system. To assign crew members to reserve crew for the scheduled flights, an estimate of a desired quantity of reserve crew for each day is input into the crew rostering system. If the estimated quantity of crew members assigned to reserve duty is too low, disruption or cancellation of flights due to crew shortage may result. To avoid customer issues with disrupted or cancelled flights, the estimate of the quantity of crew members assigned to reserve duty is typically too high. If the estimated quantity is too high, then on the day of operation many of the reserve crew are unused, which results in economic loss for the airline.

### SUMMARY OF THE DISCLOSURE

In accordance with one aspect of the disclosure, a reserve system is disclosed. The system includes a controller configured to: receive a quantity of scheduled flights for an aircraft family or aircraft type for each day in a future time period; receive a crew-grouping associated with the aircraft family or aircraft type; receive a historical data set associated with the crew-grouping for a previous time period, the historical data set including a quantity of actual flights per day for the crew-grouping and a quantity of actual used reserve of the crew-grouping per day for the aircraft family or aircraft type; determine a quantity of forecasted reserve for the crew-grouping for the quantity of scheduled flights in the future time period; and transmit the quantity of forecasted reserve to a crew rostering system in communication with the reserve system. The quantity of forecasted reserve for the crew-grouping for the quantity of scheduled flights in the future time period may be determined based on: (a) an interquartile range (IQR) of values in the historical data set for the quantity of actual used reserve of the crew-grouping per day for the aircraft family or aircraft type; or (b) the quantity of scheduled flights per day in the future time period and a transformed interquartile range (IQR_{T}) of a plurality of data points associated with the historical data set, wherein each of the plurality of data points comprises the quantity of actual used reserve of the crew-grouping per day and the quantity of actual flights per day associated with the quantity of actual used reserve of the crew-grouping per day.

In accordance with another aspect of the disclosure, a method for determining a quantity of forecasted reserve for scheduling of a reserve crew is disclosed. The method comprises: receiving, by a controller, a quantity of scheduled flights for an aircraft for each day in a future time period; receiving, by the controller, a crew-grouping associated with the aircraft; receiving, by the controller, a historical data set associated with the crew-grouping for a previous time period, the historical data set including a quantity of actual flights per day for the crew-grouping and a quantity of actual used reserve of the crew-grouping per day for the aircraft; determining, by the controller, the quantity of forecasted reserve for the crew-grouping for the quantity of scheduled flights in the future time period based on: (a) an interquartile range (IQR) of values in the historical data set for the quantity of actual used reserve of the crew-grouping per day for the aircraft; or (b) the quantity of scheduled flights per day in the future time period and a transformed interquartile range (IQR_{T}) of a plurality of data points associated with the historical data set; and providing the quantity of forecasted reserve to a crew rostering system for scheduling a crew member as reserve crew for the crew-grouping. Each of the plurality of data points comprises the quantity of actual used reserve of the crew-grouping per day and the quantity of actual flights per day associated with the quantity of actual used reserve of the crew-grouping per day. The aircraft may be an aircraft family or an aircraft type.

In accordance with a further aspect of the disclosure, a reserve system is disclosed. The system includes a controller configured to receive a quantity of scheduled flights for an aircraft family or an aircraft type for each day in a future time period; receive a crew-grouping associated with the aircraft family or aircraft type; receive a historical data set associated with the crew-grouping for a previous time period, the historical data set including a quantity of actual flights for each day for the crew-grouping in the previous time period and a quantity of actual used reserve of the crew-grouping each day for the aircraft family or the aircraft type in the previous time period; plot plurality of data points for a plurality of days in the previous time period to create a scatter plot, each data point of the plurality of data points representative of a quantity of actual used reserve of the crew-grouping associated with the quantity of actual flights on a day in the plurality of days; determine a coefficient of determination for a continuous linear regression model fitted to the plot of the plurality of data points; when the coefficient of determination is at least a coefficient threshold, determine a quantity of forecasted reserve based on the quantity of scheduled flights per day in the future time period and an IQR_{T} of the plurality of data points associated with the historical data set; and when the coefficient of determination is less than the coefficient threshold, determine the quantity of forecasted reserve based on an IQR of values in the historical data set for the quantity of actual used reserve of the crew-grouping per day for the aircraft family or aircraft type. The controller further configured to transmit the quantity of forecasted reserve to a crew rostering system configured to schedule a crew member as reserve crew for the crew-grouping.

### BRIEF DESCRIPTION OF THE DRAWINGS

FIG. 1 depicts an example of a flight planning system;

FIG. 2 depicts an example of a method of determining a quantity of forecasted reserve, in accordance with an example of the present disclosure;

FIG. 3 illustrates an exemplary scatter plot and a continuous linear regression model fit to an exemplary plurality of data points;

FIG. 4 illustrates an example of a plurality of exemplary data points plotted for the previous time period and the associated interquartile range (IQR);

FIG. 5 illustrates an example of a plurality of exemplary data points plotted for the previous time period and the associated transformed interquartile range (IQR_{T});

FIG. 6 depicts an example of the plurality of exemplary data points of FIG. 5 plotted for the previous time period and a non-transformed IQR; and

FIG. 7 illustrates the difference between the transformed outlier upper threshold T_{T} of the transformed interquartile range IQR_{T} versus the outlier upper threshold T of the non-transformed IQR for the exemplary data points of FIG. 5.

### DETAILED DESCRIPTION

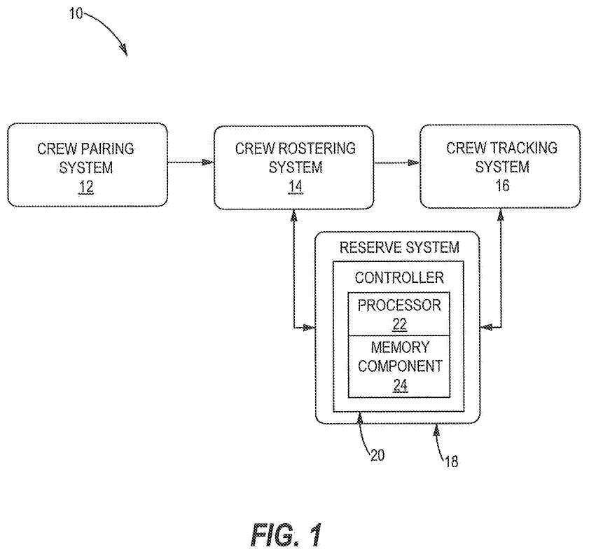

FIG. 1 illustrates an example of a flight planning system 10. The flight planning system 10 includes a crew pairing system 12, a crew rostering system 14 in communication with the crew pairing system 12, a crew tracking system 16 in communication with the crew rostering system 14, and a reserve system 18.

The crew pairing system 12 is configured to combine aircraft flights scheduled in a future time period into flight patterns that start from and end at the same (crew) base, as noted above, such flight patterns are referred to herein as scheduled flights.

The crew rostering system 14 receives such scheduled flights for a future time window from the crew pairing system 12 for an aircraft (e.g., an aircraft family, or an aircraft type of an aircraft family). Aircraft are typically classified by the aircraft family and the aircraft type. Within each aircraft family there may be one or more aircraft types. For example, in the (Boeing) 737 aircraft family there are a plurality of aircraft types: 73J, 73M, 73Q, etc. The aircraft types may differ within the aircraft family by various aspects such as passenger seats, length of fuselage, the presence/absence of certain features, etc. The crew rostering system 14 receives from the reserve system 18 a quantity of forecasted reserve Φ for a crew-grouping for a future time window for an aircraft (e.g., an aircraft family, or an aircraft type of an aircraft family). The crew rostering system 14 is configured to assign crew members to crew-groupings on the scheduled flights of the aircraft (e.g., the aircraft family or the aircraft type) to ground duties or to reserve duties. Each crew-grouping includes one or more crew parameters such as rank, base, technical qualifications, languages spoken, or the like. A crew-grouping is not limited to the aforementioned crew parameters. The technical qualification(s) identify aircraft type(s) that a crew member is authorized to operate or fly. The crew parameters may vary with different crew-groupings. For example, in one example of a crew-grouping for a pilot, the crew-grouping may include rank, base and one or more technical qualifications (e.g., aircraft types which the pilot is authorized to operate). In another example, a crew-grouping for a flight attendant may include rank and base (but may not include a technical qualification as such flight attendant may be multi-fleet qualified). The quantity of reserve crew scheduled for reserve duty for a crew-grouping for an aircraft (e.g., an aircraft family or an aircraft type) by the crew rostering system 14 is based on, or may be, the quantity of forecasted reserve Φ determined by the reserve system 18 for such crew-grouping (for such aircraft family or aircraft type). In an example, crew rostering system 14 may be receive (electronically or otherwise) the quantity of forecasted reserve Φ from the reserve system 18.

The crew rostering system 14 may be configured to transmit to the reserve system 18: a quantity of scheduled flights for each day in a future time period for an aircraft (e.g., an aircraft family or an aircraft type); and a crew-grouping associated with such aircraft (e.g., aircraft family or aircraft type).

The crew tracking system 16 is configured to receive and monitor crew assignments received from the crew rostering system 14. The crew tracking system 16 is configured to transmit to the reserve system 18 a historical data set associated with crew-grouping for a previous time period. The historical data set includes a quantity of actual flights per day for the crew-grouping and an associated quantity of actual used reserve of a crew-grouping per day for the aircraft (e.g., for the aircraft family or for the aircraft type).

As shown in the example of FIG. 1, the reserve system 18 includes a controller 20 that may include a processor 22 and a memory component 24. The reserve system 18 (and its controller 20) is in operable communication with the crew tracking system 16 and the crew rostering system 14. The controller 20 is configured to receive from the crew rostering system 14 the quantity of scheduled flights for each day in a future time period for an aircraft (e.g., for an aircraft family or for an aircraft type). The controller 20 is also configured to receive, from the crew rostering system 14, a crew-grouping associated with the aircraft (e.g., the aircraft family or the aircraft type) for which a quantity of forecasted reserve Φ needs to be calculated.

The controller 20 is further configured to receive, from the crew tracking system 16, a historical data set associated with the crew-grouping for a previous time period. The historical data set includes a quantity of actual flights Xₙ per day for the crew-grouping in the previous time period and an associated quantity of actual used reserve Yₙ for the crew-grouping per day for an aircraft (e.g., the aircraft family or for the aircraft type) in the previous time period.

The controller 20 is also configured to plot a plurality of data points (Xₙ, Yₙ) for a plurality of days in the previous time period to create a scatter plot and to fit a linear regression model, for example to fit a continuous linear regression model, to the plurality of data points (Xₙ, Yₙ). Each data point (Xₙ, Yₙ) (of the plurality of data points) is representative of the quantity of actual used reserve associated with the quantity of actual flights on a given day (in the plurality of days in the previous time period). Xₙ equals the quantity of actual flights on day “n” in the historical data set, and Yₙ equals the quantity of actual used reserve on day n associated with Xₙ. The controller 20 is further configured to determine a coefficient of determination for the continuous linear regression model fitted to the plot of the plurality of data points (Xₙ, Yₙ).

The controller 20 is configured to determine an interquartile range (IQR) and outlier upper threshold T for the plurality of data points (Xₙ, Yₙ), or a transformed interquartile range (IQR_{T}) and transformed outlier upper threshold T_{T} for the plurality of data points (Xₙ, Yₙ). When the coefficient of determination is at least a coefficient threshold, the controller 20 is configured to determine the quantity of forecasted reserve Φ based on the quantity of scheduled flights per day in the future time period and the IQR_{T} of the plurality of data points (Xₙ, Yₙ) associated with the historical data set. More specifically, when the coefficient of determination is at least a coefficient threshold, the controller 20 is configured to determine the quantity of forecasted reserve Φ based on the quantity of scheduled flights per day in the future time period and the transformed outlier upper threshold T_{T} of the IQR_{T}. When the coefficient of determination is less than a coefficient threshold, the controller 20 is configured to determine the quantity of forecasted reserve Φ based on the IQR of the values in the historical data set for the quantity of actual used reserve Yₙ of the crew-grouping per day for the aircraft (e.g., aircraft family or for the aircraft type). More specifically, when the coefficient of determination is less than a coefficient threshold, the controller 20 is configured to determine the quantity of forecasted reserve Φ based on the outlier upper threshold T of such IQR. The controller 20 may be further configured to transmit the quantity of forecasted reserve Φ to the crew rostering system 14.

The processor 22 may be a microcontroller, a digital signal processor (DSP), an electronic control module (ECM), an electronic control unit (ECU), a microprocessor or any other suitable processor 22 as known in the art. The processor 22 may execute instructions and generate control signals for calculating, for example, the coefficient of determination, the IQR, the outlier upper threshold T, the IQR_{T}, the transformed outlier upper threshold T_{T}, the quantity of forecasted reserve E, or the like. Such instructions may be read into or incorporated into a computer readable medium, such as the memory component 24 or provided external to the processor 22. In alternative examples, hard wired circuitry may be used in place of, or in combination with, software instructions to implement a control method.

The term “computer readable medium” as used herein refers to any non-transitory medium or combination of media that participates in providing instructions to the processor 22 for execution. Such a medium may comprise all computer readable media except for a transitory, propagating signal. Common forms of computer-readable media include, for example, a floppy disk, a flexible disk, hard disk, magnetic tape, or any other magnetic medium, a CD-ROM, any other optical medium, or any other computer readable medium.

The controller 20 is not limited to one processor 22 and memory component 24. The controller 20 may include several processors 22 and memory components 24. In an example, the processors 22 may be parallel processors that have access to a shared memory component(s) 24. In another example, the processors 22 may be part of a distributed computing system in which a processor 22 (and its associated memory component 24) may be located remotely from one or more other processor(s) 22 (and associated memory components 24) that are part of the distributed computing system. The controller 20 may also be configured to retrieve from the memory component 24 and formulas and other data necessary for the calculations discussed herein.

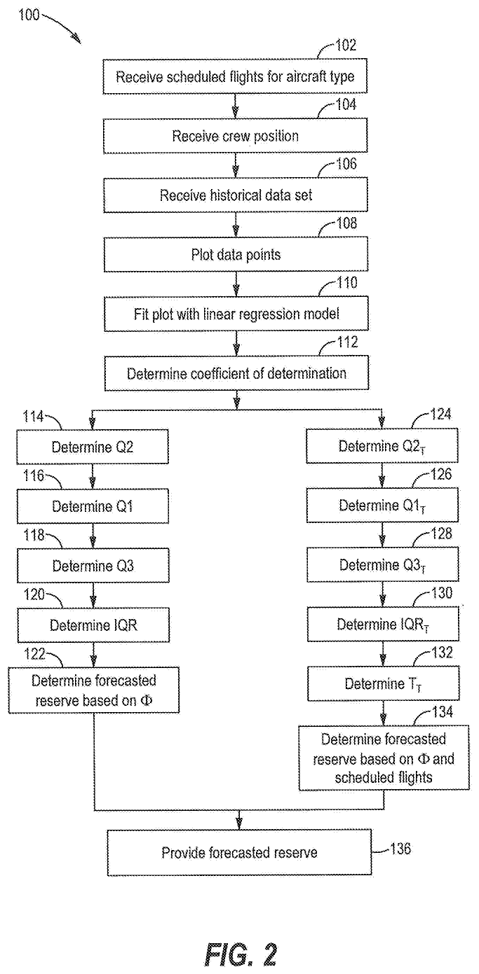

Referring now to FIG. 2, an exemplary flowchart is illustrated showing sample blocks which may be followed to determine a quantity of forecasted reserve Φ. The method 100 may be practiced with more or less than the number of blocks shown and is not limited to the order shown.

While, the aspects of the method 100 will be explained throughout the disclosure, and in the discussion of FIG. 2, the method 100 includes receiving, by a controller 20, a quantity of scheduled flights for an aircraft (e.g., an aircraft family or an aircraft type) for each day in a future time period; receiving, by the controller 20, a crew-grouping associated with the aircraft (e.g., the aircraft family or the aircraft type); receiving, by the controller 20, a historical data set associated with the crew-grouping for a previous time period, the historical data set including a quantity of actual flights per day for the crew-grouping and a quantity of actual used reserve of the crew-grouping per day for the aircraft (e.g., the aircraft family or the aircraft type); determining, by the controller 20, the quantity of forecasted reserve Φ for the crew-grouping for the quantity of scheduled flights in the future time period based on: (a) an IQR of values in the historical data set for the quantity of actual used reserve Yₙ of the crew-grouping per day for the aircraft (e.g., aircraft family or the aircraft type); or (b) the quantity of scheduled flights per day in the future time period and a IQR_{T} of a plurality of data points (Xₙ, Yₙ) associated with the historical data set; and providing the quantity of forecasted reserve Φ to a crew rostering system 14 for scheduling one or more crew members as reserve crew for the crew-grouping, wherein each of the plurality of data points (Xₙ, Yₙ) comprises the quantity of actual used reserve Yₙ of the crew-grouping per day and the quantity of actual flights Xₙ per day associated with the quantity of actual used reserve Yₙ of the crew-grouping per day.

At block 102, the controller 20 receives a quantity of scheduled flights X_{Fn} for each day n in a future time period for an aircraft (e.g., an aircraft family or aircraft type). For example, in one example, the aircraft may be an aircraft type of a 73J (of the 737 family). In another example, the aircraft may be an aircraft family of a 737. In an example, such quantity of scheduled flights X_{Fn} may be received from the crew rostering system 14.

At block 104, the controller 20 receives a crew-grouping associated with the aircraft (e.g., aircraft family or the aircraft type). In an example, such crew-grouping may be received from the crew rostering system 14. As discussed earlier, the crew-grouping includes one or more crew parameters such as rank, base, technical qualifications, languages spoken, or the like, and the crew-grouping is not limited to the aforementioned crew parameters. The technical qualification(s) identify aircraft type(s) that a crew member is authorized to operate or fly. The crew parameters may vary with different crew-groupings. For example, in one example, the crew-grouping for a pilot may include the rank, the base and one or more technical qualification(s) (e.g., aircraft types that the pilot is authorized/qualified to operate). In another example, the crew-grouping for a flight attendant may include the rank and the base. In yet another example, the crew-grouping may include the rank, the base and a language spoken.

At block 106, the controller 20 receives a historical data set associated with the crew-grouping for a previous time period. In an example, the controller 20 may receive such historical data set from the crew tracking system 16. The historical data set includes (1) a quantity of actual flights Xₙ for each day n in the previous time period, and (2) a quantity of actual used reserve Yₙ (of the crew-grouping) for each day n for the aircraft (e.g., aircraft family or the aircraft type) in the previous time period. As used herein, n is a number greater than zero and identifies the sequence position of the day (e.g., day 1, day 2, day 3, etc.) in the applicable previous or a future time period, depending on the context in which it is used. For example, in one example, the previous time period may be the month of January, and n may be a number 1 to 31 (inclusive of the endpoints), representing day 1, or day 2, or day 3, etc. in the month of January.

At block 108, the controller 20 plots a plurality of data points (Xₙ, Yₙ) based on the historical data set for the previous time period to create a scatter plot. Xₙ equals the quantity of actual flights on day “n” in the historical data set, and Yₙ equals the quantity of actual used reserve on day n associated with Xₙ.

At block 110, the controller 20 fits the scatter plot of block 108 with a linear regression model, for example the continuous linear regression model Y. In an example, the continuous linear regression model Y may be defined by equation (1). The continuous linear regression model Y is fitted to the scatter plot so as to predict the quantity of used reserve (hereinafter, referred to as “predicted used reserve”) associated with the quantity of actual flights Xₙ per each day n in previous time period.

Y=B₀+B₁Xₙ, (1)
where Xₙ=the quantity of actual flights on day n
   Y=a quantity of predicted used reserve associated with Xₙ
   B₀=the Y-axis intercept
   B₁=the slope

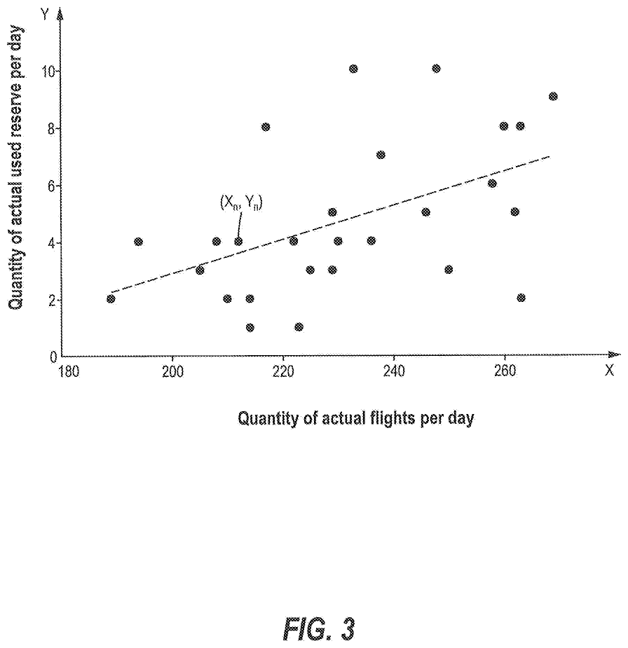

FIG. 3 illustrates an exemplary scatter plot and continuous linear regression model Y fit to the plurality of data points (Xₙ, Yₙ) for an exemplary previous time period. Points falling on line Y represent the quantity of predicted used reserve (according to the model Y) per quantity of actual flights Xₙ.

At block 112, the controller 20 determines a coefficient of determination for the continuous linear regression model Y utilized in block 110 for the previous time period. The (value of the) coefficient of determination is indicative of a presence (or an absence) of a strong correlation between the number of actual flights Xₙ and the number of actually used reserves. If the coefficient of determination is less than a coefficient threshold, the method 100 proceeds to block 114, otherwise method 100 proceed to block 124. In one example, the coefficient threshold may be 0.3, although other coefficient thresholds may be utilized depending on the desired strength of correlation.

In blocks 114-122, the controller 20 determines a quantity of forecasted reserve Φ of the crew-grouping for a quantity of scheduled flights X_{F}n in a future time period based on an outlier upper threshold T for an interquartile range (IQR) of the data points (Xₙ, Yₙ) for the previous time period for the crew-grouping for the aircraft (e.g., aircraft family or aircraft type). Since the coefficient of determination is low (less than a coefficient threshold), the influence of each Xₙ value on the outcome is also low; as a result, the calculations may be simplified to utilize only Yₙ.

At block 114, the controller 20 determines the median of the spread of the plurality of data points for Yₙ associated with the plurality of days in the historical data set for the previous time period by calculating the second quartile Q2 for such data points Yₙ (where Yₙ equals the quantity of actual used reserve on day n).

At block 116, the controller 20 determines the first quartile Q1, wherein Q1 is the median of the data points Yₙ in the historical data set for the previous time period that are below Q2.

At block 118, the controller 20 determines the third quartile Q3, wherein Q3 is the median of the data points Yₙ in the historical data set for the previous time period that are above Q2.

At block 120, the controller 20 determines the IQR for the plurality of data points Yₙ in the historical data set for the previous time period according to equation (2) below. As IQR calculations are known in the art, a description of such calculation is not elaborated on herein.

IQR=Q3−Q1 (2)

At block 122, the controller 20 utilizes equation (3) for the outlier upper threshold T of the IQR to determine the forecasted reserve Φ for a future time period:

Φ=T=Q3+1.5*IQR (3)

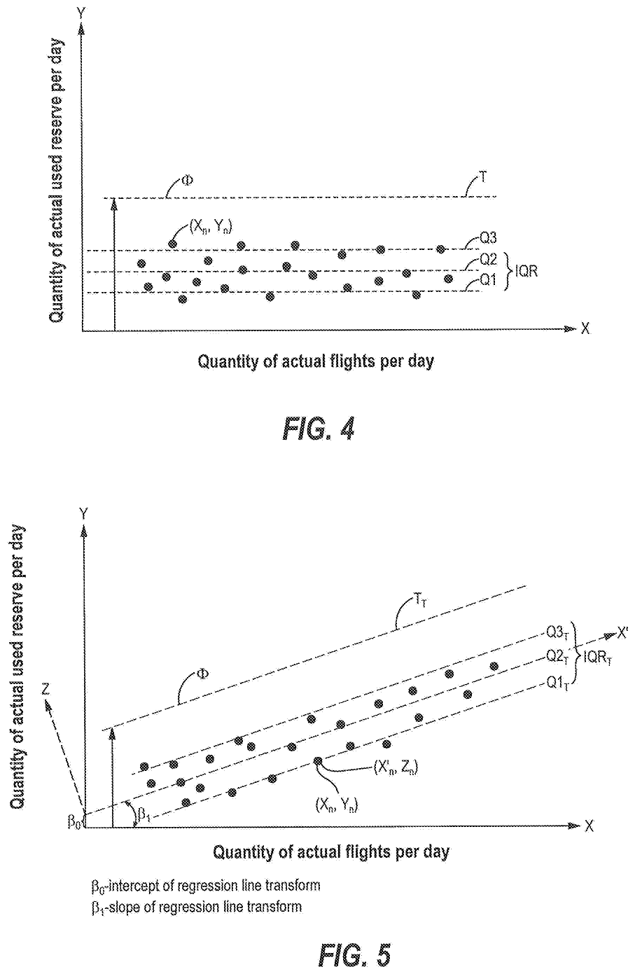

Quantities of reserve (for a crew-grouping) above the outlier upper threshold T for Yₙ as determined by the historical data set are considered to be outliers that differ significantly enough from the other values for Yₙ in the historical data set (for the previous time period) so as to be considered quantities of reserve that are unlikely to be needed in the future time period. Typically outliers represent quantities of used reserve that resulted from unpredictable events that were beyond normal expectations for given scenarios. FIG. 4 illustrates an example of a plurality of exemplary data points (Xₙ, Yₙ) plotted for the previous time period and the associated IQR, first quartile Q1, second quartile Q2, third quartile Q3 and resulting the forecasted reserve Φ for scheduled flights in a future time period that is based on the outlier upper threshold T of the IQR for the previous time period. The quantity of forecasted reserve Φ may be rounded up (or down) to the nearest whole number. Once the quantity of forecasted reserve Φ is determined, the method 100 proceeds to block 136.

When the correlation between the data points and the continuous linear regression model is reasonably good, for example when the coefficient of determination is at least the coefficient threshold (in this scenario, at least 0.3), the use of IQR based analysis to forecast reserve for a crew-grouping can be refined to determine a forecasted reserve Φ that varies with the quantity of scheduled flights X_{Fn} in a future time period.

In blocks 124 to 134, when the coefficient of determination is at least the threshold (0.3 in this example), the controller 20 determines a quantity of forecasted reserve Φ for the crew position that varies with the quantity of scheduled flights X_{Fn} of an aircraft (e.g., an aircraft family or aircraft type) in a future time period.

For the purposes of explanation, FIG. 5 illustrates an example of a plurality of exemplary data points (Xₙ, Yₙ) plotted for the previous time period. In this scenario, it is assumed that the continuous linear regression model Y approximates the median Q2 of the spread of the plurality of data points (Xₙ, Yₙ) in the historical data set of the previous time period, where Xₙ equals the quantity of actual flights on day “n” in the historical data set, and Yₙ equals the quantity of actual used reserve on day n associated with Xₙ.

As shown in FIG. 5, the axes (X, Y) are considered to be transformed by a rotation (at the Y-intercept B₀) on the angle that corresponds to the slope parameter B₁ of the continuous linear regression model Y=B₀+B₁X and a new system of coordinates (X′, Z) is obtained by the transform.

An interquartile range, referred to herein as a transformed interquartile range (IQR_{T}), is found for the data points (X′ₙ, Zₙ) in this new system of coordinates (X′, Z). X′ₙ equals the quantity of actual flights on day “n” in the historical data set, and Zₙ equals the quantity of actual used reserve on day n associated with X′ₙ. The first quartile of the IQR_{T} is referred to as the transformed first quartile Q1^{T}, the second quartile of the IQR_{T} is referred to as the transformed second quartile Q2^{T} (the median of the spread of the plurality of data points (X′ₙ, Zₙ) in this transformed system of coordinates), the third quartile of the IQR_{T} is referred to as the transformed third quartile Q3_{T} and the resulting outlier upper threshold resulting is T_{T}. As explained further below, the quantity of forecasted reserve Φ for scheduled flights X_{Fn} in a future time period may be based on the outlier upper threshold T_{T} for the transformed interquartile range IQR_{T} for this previous time period.

In block 124, the controller 20 determines the transformed second quartile Q2_{T} for the plurality of data points (Xₙ, Yₙ) in the historical data set of the previous time period, wherein Q2_{T} is equal to the continuous linear regression model Y as shown in equation (4):

Q2_{T}=B₀+B₁Xₙ (4)
where Xₙ=the quantity of actual flights in day n,
   B₀=the Y-intercept of the continuous linear regression model
   B₁=the slope of the continuous linear regression model

In block 126, the controller 20 determines the transformed first quartile, Q1_{T}. Q1_{T} is equal to the median of the plurality of data points (X′ₙ, Zₙ) of the previous time period that are below Q2_{T}.

In block 128, the controller 20 determines the transformed third quartile, Q3_{T}. Q3_{T} is equal to the median of the plurality of data points (X′ₙ, Zₙ) of the previous time period that are above Q2_{T}.

In block 130, the controller 20 determines the IQR_{T} for the plurality of data points (X′ₙ, Zₙ) of the previous time period according to equation (5):

IQR_{T}=Q3_{T}−Q1_{T} (5)

In block 132, the controller 20 utilizes equation (6) to determine the transformed outlier upper threshold T_{T} of IQR_{T}:

T_{T}=Q3_{T}+1.5*IQR_{T} (6)

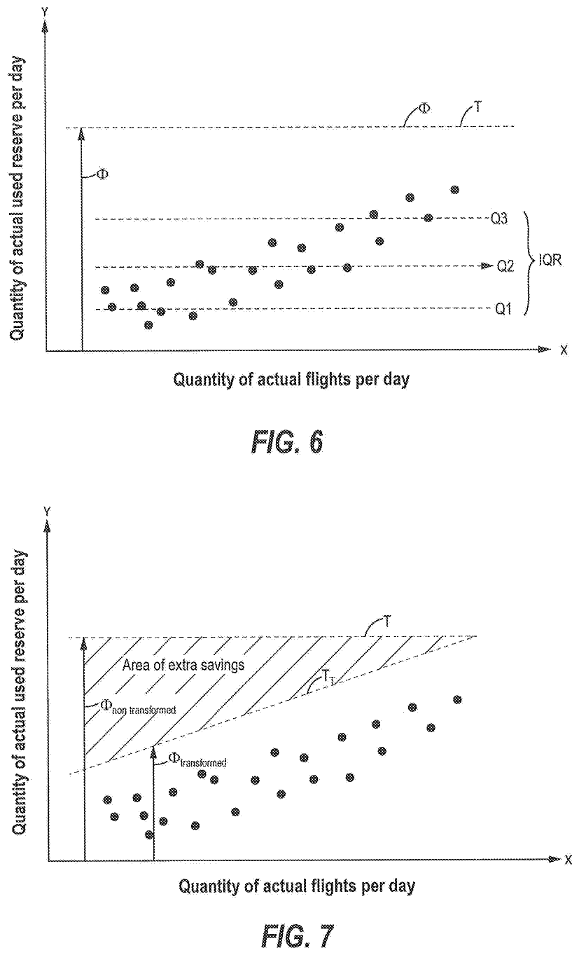

As can be seen in FIG. 5, a forecasted reserve Φ that is based on the transformed outlier upper threshold T_{T} of IQR_{T} varies with the quantity of actual flights. As a matter of comparison FIG. 6 illustrates the outlier upper threshold T had the IQR for this particular exemplary historical data set of FIG. 5 not been transformed. As can be seen, when the IQR was not transformed for this particular historical data set, the outlier upper threshold T was larger because the spread of the data points was larger. FIG. 7 illustrates the difference between the transformed outlier upper threshold T_{T} of the transformed IQR_{T} versus the outlier upper threshold T of the non-transformed IQR for the exemplary data points (Xₙ, Yₙ) in this historical data set of FIG. 5. This difference is indicative of the savings that a forecasted reserve (based the transformed IQR_{T} may provide over a forecasted reserve Φ based a non-transformed IQR, in appropriate scenarios.

In block 134, the controller 20 determines a quantity of forecasted reserve Φ for the quantity of scheduled flights in a day n of a future time period, according to equation (7):

Φ=T_{T}=Q3_{T}+1.5*IQR_{T} (7)

where
Q2_{T}=B₀+B₁X_{Fn},
X_{Fn}=the quantity of scheduled flights in day n of the future time period,
B₀=the Y intercept of the continuous linear regression model in the previous time period
B₁=the slope of the continuous linear regression model in the previous time period
Q1_{T} is the value for the median of data points (X′ₙ, Zₙ) of the previous time period that are below Q2_{T} when the value of X′ₙ=X_{Fn}
Q3_{T} is the value of the median of data points (X′ₙ, Zₙ) of the previous time period that are above Q2_{T} when the value of X′ₙ=X_{Fn}

In this scenario, it is assumed that the continuous linear regression model of the selected previous time period will be similar to that of the future time period and X_{Fn}, the quantity of scheduled flights on day n of the future time period, is substituted for Xₙ, the quantity of actual flights in day n of the previous time period, in equation (4) for Q2_{T}. The controller 20 determines Q1_{T}, the value for the median of data points (X′ₙ, Zₙ) of the previous time period, that are below Q2_{T} when the value of X′ₙ=X_{Fn}. The controller 20 determines Q3_{T}, the value of the median of data points (X′ₙ, Zₙ) of the previous time period that are above Q2_{T}, when the value of X′ₙ=X_{Fn}. The controller 20 determines the IQR_{T} and then the forecasted reserve Φ for the quantity of scheduled flights in a day n of the future time period. The process of block 134 is repeated for each quantity of scheduled flights per day of the future time period to obtain a forecasted reserve for each day n in a future time period for which flights are scheduled. The quantity of forecasted reserve Φ for each day n may be rounded up (or down) to the nearest whole number.

At block 136, the forecasted reserve Φ of crew members is provided to the crew rostering system 14. In one example, the reserve system 18 transmits the forecasted reserve Φ for the quantity of scheduled flights scheduled for each day n of the future time period.

The crew rostering system 14 is configured to schedule the quantity of reserve crew (members) for reserve duty (once scheduled, referred to herein as “scheduled reserve”) for a crew-grouping for the aircraft (e.g., aircraft family or aircraft type) each day in the future time period based on the forecasted reserve Φ for the quantity of scheduled flights scheduled for each day n of the future time period. In some examples, the scheduled reserve may equal the forecasted reserve Φ determined by the reserve system 18. In other examples the scheduled reserve may be based on the forecasted reserve Φ determined by the crew reserve system 18 but adjusted. For example, a value may be added or subtracted from the forecasted reserve Φ determined by the crew reserve system 18 because of other considerations (margin of error, predicted spike or cancellation of scheduled flights, or the like).

### INDUSTRIAL APPLICABILITY

In general, the foregoing disclosure finds utility in applications relating to the forecasting and scheduling of crew members for reserve duty for crew-groupings for scheduled flights. In particular, use of the teachings herein provide tools to commercial airlines to improve service and reduce cost by assisting such airlines with scheduling quantities of reserve crew that avoid disruption or cancellation of flights due to crew shortage while reducing the quantities of unused reserve crew and the associated cost.

While the preceding text sets forth a detailed description of numerous different examples, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

Clause 1: A reserve system comprising a controller configured to receive a quantity of scheduled flights for an aircraft family or aircraft type for each day in a future time period; receive a crew-grouping associated with the aircraft family or aircraft type; receive a historical data set associated with the crew-grouping for a previous time period, the historical data set including a quantity of actual flights per day for the crew-grouping and a quantity of actual used reserve of the crew-grouping per day for the aircraft family or aircraft type; determine a quantity of forecasted reserve for the crew-grouping for the quantity of scheduled flights in the future time period based on: (a) an interquartile range (IQR) of values in the historical data set for the quantity of actual used reserve of the crew-grouping per day for the aircraft family or aircraft type; or (b) the quantity of scheduled flights per day in the future time period and a transformed interquartile range (IQR_{T}) of a plurality of data points associated with the historical data set; and transmit the quantity of forecasted reserve to a crew rostering system in communication with the reserve system, wherein each of the plurality of data points comprises the quantity of actual used reserve of the crew-grouping per day and the quantity of actual flights per day associated with the quantity of actual used reserve of the crew-grouping per day.

Clause 2: The system of Clause 1, wherein the crew-grouping includes a rank and a base.

Clause 3: The system of Clause 2, wherein the crew-grouping further includes one or more technical qualifications.

Clause 4: The system of any of Clauses 1-3, wherein the quantity of forecasted reserve is further based on an outlier upper threshold for the IQR or a transformed outlier upper threshold for the IQR_{T}.

Clause 5: The system of any of Clauses 1-4, in which the controller is further configured to determine a coefficient of determination for a continuous linear regression model fitted to the plurality of data points.

Clause 6: The system of Clause 5, in which the controller is further configured to plot the plurality of data points and to fit the continuous linear regression model to the plurality of data points.

Clause 7: The system of Clause 5 or 6, wherein the controller is configured to, when the coefficient of determination is at least a coefficient threshold, determine the quantity of forecasted reserve based on the quantity of scheduled flights per day in the future time period and the IQR_{T} of the plurality of data points associated with the historical data set.

Clause 8: The system of any of Clauses 5-7, wherein the controller is configured to, when the coefficient of determination is less than a coefficient threshold, determine the quantity of forecasted reserve based on the IQR of the values in the historical data set for the quantity of actual used reserve of the crew-grouping per day for the aircraft family or aircraft type.

Clause 9: A method for determining a quantity of forecasted reserve for scheduling a reserve crew, the method comprising receiving, by a controller, a quantity of scheduled flights for an aircraft for each day in a future time period; receiving, by the controller, a crew-grouping associated with the aircraft; receiving, by the controller, a historical data set associated with the crew-grouping for a previous time period, the historical data set including a quantity of actual flights per day for the crew-grouping and a quantity of actual used reserve of the crew-grouping per day for the aircraft; determining, by the controller, the quantity of forecasted reserve for the crew-grouping for the quantity of scheduled flights in the future time period based on: (a) an interquartile range (IQR) of values in the historical data set for the quantity of actual used reserve of the crew-grouping per day for the aircraft; or (b) the quantity of scheduled flights per day in the future time period and a transformed interquartile range (IQR_{T}) of a plurality of data points associated with the historical data set; and providing the quantity of forecasted reserve to a crew rostering system for scheduling a crew member as reserve crew for the crew-grouping, wherein each of the plurality of data points comprises the quantity of actual used reserve of the crew-grouping per day and the quantity of actual flights per day associated with the quantity of actual used reserve of the crew-grouping per day, and wherein the aircraft is an aircraft family or an aircraft type.

Clause 10: The method of Clause 9, wherein the aircraft is an aircraft type.

Clause 11: The method of Clause 10, wherein the crew-grouping includes a rank, a base and a technical qualification.

Clause 12: The method of any of Clauses 9-10, wherein the crew-grouping includes a rank and a base.

Clause 13: The method of any of Clauses 9-12, wherein the quantity of forecasted reserve is based on an outlier upper threshold for the IQR or a transformed outlier upper threshold for the IQR_{T}.

Clause 14: The method of Clause 13 further comprising determining, by the controller, a coefficient of determination for a continuous linear regression model fitted to the plurality of data points.

Clause 15: The method of Clause 14, wherein, when the coefficient of determination is less than a coefficient threshold, determining the quantity of forecasted reserve based on the IQR of the values in the historical data set for the quantity of actual used reserve of the crew-grouping per day for the aircraft.

Clause 16: The method of Clause 14, wherein, when the coefficient of determination is at least a coefficient threshold, determining the quantity of forecasted reserve based on the quantity of scheduled flights per day in the future time period and the IQR_{T} of the plurality of data points associated with the historical data set.

Clause 17: A reserve system comprising a controller configured to receive a quantity of scheduled flights for an aircraft family or an aircraft type for each day in a future time period; receive a crew-grouping associated with the aircraft family or aircraft type; receive a historical data set associated with the crew-grouping for a previous time period, the historical data set including a quantity of actual flights for each day for the crew-grouping in the previous time period and a quantity of actual used reserve of the crew-grouping each day for the aircraft family or the aircraft type in the previous time period; plot plurality of data points for a plurality of days in the previous time period to create a scatter plot, each data point of the plurality of data points representative of a quantity of actual used reserve of the crew-grouping associated with the quantity of actual flights on a day in the plurality of days; determine a coefficient of determination for a continuous linear regression model fitted to the plot of the plurality of data points; when the coefficient of determination is at least a coefficient threshold, determine a quantity of forecasted reserve based on the quantity of scheduled flights per day in the future time period and an IQR_{T} of the plurality of data points associated with the historical data set; when the coefficient of determination is less than the coefficient threshold, determine the quantity of forecasted reserve based on an IQR of values in the historical data set for the quantity of actual used reserve of the crew-grouping per day for the aircraft family or aircraft type; and transmit the quantity of forecasted reserve to a crew rostering system configured to schedule a crew member as reserve crew for the crew-grouping.

Clause 18: The system of Clause 17, wherein the crew-grouping includes a rank and a base.

Clause 19: The system of Clause 18, wherein the crew-grouping further includes one or more technical qualifications.

Clause 20: The system of any of Clauses 17-19, wherein the quantity of forecasted reserve is further based on: (a) an outlier upper threshold for the IQR when the coefficient of determination is less than the coefficient threshold and (b) a transformed outlier upper threshold for the IQR_{T} when the coefficient of determination is at least the coefficient threshold.

What is claimed is:

1. A reserve system comprising:
a controller configured to:
receive a quantity of scheduled flights for an aircraft family or aircraft type for each day in a future time period;
receive a crew-grouping associated with the aircraft family or aircraft type;
receive a historical data set associated with the crew-grouping for a previous time period, the historical data set including a quantity of actual flights per day for the crew-grouping and a quantity of actual used reserve of the crew-grouping per day for the aircraft family or aircraft type;
determine a quantity of forecasted reserve for the crew-grouping for the quantity of scheduled flights in the future time period based on: (a) an interquartile range (IQR) of values in the historical data set for the quantity of actual used reserve of the crew-grouping per day for the aircraft family or aircraft type; or (b) the quantity of scheduled flights per day in the future time period and a transformed interquartile range (IQR_{T}) of a plurality of data points associated with the historical data set; and
transmit the quantity of forecasted reserve to a crew rostering system in communication with the reserve system,
wherein each of the plurality of data points comprises the quantity of actual used reserve of the crew-grouping per day and the quantity of actual flights per day associated with the quantity of actual used reserve of the crew-grouping per day.

2. The reserve system of claim 1, wherein the crew-grouping includes a rank and a base.

3. The reserve system of claim 2, wherein the crew-grouping further includes one or more technical qualifications.

4. The reserve system of claim 1, wherein the quantity of forecasted reserve is further based on an outlier upper threshold for the IQR or a transformed outlier upper threshold for the IQR_{T}.

5. The reserve system of claim 1, in which the controller is further configured to determine a coefficient of determination for a continuous linear regression model fitted to the plurality of data points.

6. The reserve system of claim 5, in which the controller is further configured to plot the plurality of data points and to fit the continuous linear regression model to the plurality of data points.

7. The reserve system of claim 5, wherein the controller is configured to, when the coefficient of determination is at least a coefficient threshold, determine the quantity of forecasted reserve based on the quantity of scheduled flights per day in the future time period and the IQR_{T} of the plurality of data points associated with the historical data set.

8. The reserve system of claim 5, wherein the controller is configured to, when the coefficient of determination is less than a coefficient threshold, determine the quantity of forecasted reserve based on the IQR of the values in the historical data set for the quantity of actual used reserve of the crew-grouping per day for the aircraft family or aircraft type.

9. A method for determining a quantity of forecasted reserve for scheduling a reserve crew, the method comprising:
receiving, by a controller, a quantity of scheduled flights for an aircraft for each day in a future time period;
receiving, by the controller, a crew-grouping associated with the aircraft;
receiving, by the controller, a historical data set associated with the crew-grouping for a previous time period, the historical data set including a quantity of actual flights per day for the crew-grouping and a quantity of actual used reserve of the crew-grouping per day for the aircraft;
determining, by the controller, the quantity of forecasted reserve for the crew-grouping for the quantity of scheduled flights in the future time period based on: (a) an interquartile range (IQR) of values in the historical data set for the quantity of actual used reserve of the crew-grouping per day for the aircraft; or (b) the quantity of scheduled flights per day in the future time period and a transformed interquartile range (IQR_{T}) of a plurality of data points associated with the historical data set; and
providing the quantity of forecasted reserve to a crew rostering system for scheduling a crew member as reserve crew for the crew-grouping,
wherein each of the plurality of data points comprises the quantity of actual used reserve of the crew-grouping per day and the quantity of actual flights per day associated with the quantity of actual used reserve of the crew-grouping per day, and
wherein the aircraft is an aircraft family or an aircraft type.

10. The method of claim 9, wherein the aircraft is an aircraft type.

11. The method of claim 10, wherein the crew-grouping includes a rank, a base and a technical qualification.

12. The method of claim 9, wherein the crew-grouping includes a rank and a base.

13. The method of claim 9, wherein the quantity of forecasted reserve is based on an outlier upper threshold for the IQR or a transformed outlier upper threshold for the IQR_{T}.

14. The method of claim 13 further comprising determining, by the controller, a coefficient of determination for a continuous linear regression model fitted to the plurality of data points.

15. The method of claim 14, wherein, when the coefficient of determination is less than a coefficient threshold, determining the quantity of forecasted reserve based on the IQR of the values in the historical data set for the quantity of actual used reserve of the crew-grouping per day for the aircraft.

16. The method of claim 14, wherein, when the coefficient of determination is at least a coefficient threshold, determining the quantity of forecasted reserve based on the quantity of scheduled flights per day in the future time period and the IQR_{T} of the plurality of data points associated with the historical data set.

17. A reserve system comprising:
a controller configured to:
receive a quantity of scheduled flights for an aircraft family or an aircraft type for each day in a future time period;
receive a crew-grouping associated with the aircraft family or aircraft type;
receive a historical data set associated with the crew-grouping for a previous time period, the historical data set including a quantity of actual flights for each day for the crew-grouping in the previous time period and a quantity of actual used reserve of the crew-grouping each day for the aircraft family or the aircraft type in the previous time period;
plot plurality of data points for a plurality of days in the previous time period to create a scatter plot, each data point of the plurality of data points representative of a quantity of actual used reserve of the crew-grouping associated with the quantity of actual flights on a day in the plurality of days;
determine a coefficient of determination for a continuous linear regression model fitted to the plot of the plurality of data points;
when the coefficient of determination is at least a coefficient threshold, determine a quantity of forecasted reserve based on the quantity of scheduled flights per day in the future time period and an IQR_{T} of the plurality of data points associated with the historical data set;
when the coefficient of determination is less than the coefficient threshold, determine the quantity of forecasted reserve based on an IQR of values in the historical data set for the quantity of actual used reserve of the crew-grouping per day for the aircraft family or aircraft type; and
transmit the quantity of forecasted reserve to a crew rostering system configured to schedule a crew member as reserve crew for the crew-grouping.

18. The reserve system of claim 17, wherein the crew-grouping includes a rank and a base.

19. The reserve system of claim 18, wherein the crew-grouping further includes one or more technical qualifications.

20. The reserve system of claim 17, wherein the quantity of forecasted reserve is further based on: (a) an outlier upper threshold for the IQR when the coefficient of determination is less than the coefficient threshold and (b) a transformed outlier upper threshold for the IQR_{T} when the coefficient of determination is at least the coefficient threshold.
